(19) United States
(12) Patent Application Publication
(10) Pub. No.: US 2025/0210926 A1
(43) Pub. Date: Jun. 26, 2025

(54) METHOD FOR MANUFACTURING OPTICAL MODULE, METHOD FOR MANUFACTURING GAS LASER DEVICE, AND MANUFACTURING JIG FOR OPTICAL MODULE

(71) Applicant: Gigaphoton Inc., Tochigi (JP)

(72) Inventors: Masakazu HATTORI, Oyama-shi (JP); Yuki ODA, Oyama-shi (JP); Tatsuo YAMAGUCHI, Oyama-shi (JP); Hirotaka MIYAMOTO, Oyama-shi (JP)

(73) Assignee: Gigaphoton Inc., Tochigi (JP)

(21) Appl. No.: 18/939,179

(22) Filed: Nov. 6, 2024

(30) Foreign Application Priority Data
Dec. 22, 2023 (JP) 2023-217101

(51) Int. Cl. H01S 3/034; H01S 3/08

(52) U.S. Cl. CPC H01S 3/034; H01S 3/08004

(57) ABSTRACT

A method for manufacturing an optical module may include a step for arranging a first autocollimator such that output light is perpendicularly incident on an incident-side surface of an output coupling mirror; an step for arranging, between the incident-side surface and the first autocollimator, an optical element including a first reflection surface and a second reflection surface facing the incident-side surface as forming an angle of 45° with the first reflection surface such that light output from the first autocollimator is perpendicularly incident on the first reflection surface; a step for arranging a second collimator such that output light is reflected by the second reflection surface and perpendicularly incident on the incident-side surface; and a step for arranging the planar mirror, after removing the optical element, such that light output from the second autocollimator is perpendicularly incident on the reflection surface.

### CROSS-REFERENCE TO RELATED APPLICATIONS

The present application claims the benefit of Japanese Patent Application No. 2023-217101, filed on Dec. 22, 2023, the entire contents of which are hereby incorporated by reference.

### BACKGROUND

### 1. Technical Field

The present disclosure relates to a manufacturing method for an optical module, a manufacturing method for a gas laser device, and a manufacturing jig for an optical module.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248.0 nm and an ArF excimer laser device for outputting laser light having a wavelength of about 193.4 nm are used.

The KrF excimer laser device and the ArF excimer laser device each have a large spectral line width of about 350 pm to 400 pm in natural oscillation light. Therefore, when a projection lens is formed of a material that transmits ultraviolet rays such as KrF laser light and ArF laser light, there is a case in which chromatic aberration occurs. As a result, the resolution may decrease. Then, a spectral line width of laser light output from the gas laser device needs to be narrowed to the extent that the chromatic aberration can be ignored. For this purpose, there is a case in which a line narrowing module (LNM) including a line narrowing element (etalon, grating, and the like) is provided in a laser resonator of the gas laser device to narrow a spectral line width. In the following, a gas laser device with a narrowed spectral line width is referred to as a line narrowing gas laser device.

### LIST OF DOCUMENTS

### Patent Documents

Patent Document 1: Japanese Patent Application No. H08-118667

Patent Document 2: Japanese Patent No. 5589397

Patent Document 3: International Publication No. WO2017/053335

### SUMMARY

According to an aspect of the present disclosure, it is disclosed a method for manufacturing an optical module including an output coupling mirror configured to transmit a part of laser light and reflect another part of the laser light, and a planar mirror including a planar reflection surface perpendicular to a surface of the output coupling mirror on an incident side of the laser light. The method includes a first autocollimator arrangement step for arranging a first autocollimator such that light output from the first autocollimator is perpendicularly incident on the surface on the incident side, while receiving light, out of the light output from the first autocollimator, reflected by the surface on the incident side; an optical element arrangement step for arranging, between the surface on the incident side and the first autocollimator, an optical element including a first reflection surface facing the first autocollimator and a second reflection surface facing the surface on the incident side as forming an angle of 45° with the first reflection surface such that light output from the first autocollimator is perpendicularly incident on the first reflection surface, while receiving light, out of the light output from the first autocollimator, reflected by the first reflection surface; a second autocollimator arrangement step for arranging a second collimator such that light output from the second autocollimator is perpendicularly incident on the surface on the incident side, while receiving light, out of the light output from the second autocollimator, reflected by the second reflection surface, the surface on the incident side, and the second reflection surface in this order; and a first mirror arrangement step for arranging the planar mirror, after removing the optical element, such that light output from the second autocollimator is perpendicularly incident on the reflection surface, while receiving light, out of the light output from the second autocollimator, reflected by the reflection surface of the planar mirror.

According to an aspect of the present disclosure, it is disclosed a method for manufacturing a gas laser device including a chamber device configured to amplify laser light output from a laser oscillator and an optical module. The optical module includes an output coupling mirror configured to transmit a part of the laser light output from the chamber device and reflect another part of the laser light output from the chamber device to be returned to the chamber device, and a planar mirror including a planar reflection surface perpendicular to a surface of the output coupling mirror on an incident side of the laser light. The method includes arranging the optical module manufactured by a method for manufacturing the optical module such that the laser light output from the chamber device is perpendicularly incident on the surface of the output coupling mirror on the incident side. The method for manufacturing the optical module includes a first autocollimator arrangement step for arranging a first autocollimator such that light output from the first autocollimator is perpendicularly incident on the surface on the incident side, while receiving light, out of the light output from the first autocollimator, reflected by the surface on the incident side; an optical element arrangement step for arranging, between the surface on the incident side and the first autocollimator, an optical element including a first reflection surface facing the first autocollimator and a second reflection surface facing the surface on the incident side as forming an angle of 45° with the first reflection surface such that light output from the first autocollimator is perpendicularly incident on the first reflection surface, while receiving light, out of the light output from the first autocollimator, reflected by the first reflection surface; a second autocollimator arrangement step for arranging a second collimator such that light output from the second autocollimator is perpendicularly incident on the surface on the incident side, while receiving light, out of the light output from the second autocollimator, reflected by the second reflection surface, the surface on the incident side, and the second reflection surface in this order; and a first mirror arrangement step for arranging the planar mirror, after removing the optical element, such that light output from the second autocollimator is perpendicularly incident on the reflection surface, while receiving light, out of the light output from the second autocollimator, reflected by the reflection surface of the planar mirror.

According to an aspect of the present disclosure, it is disclosed a manufacturing jig for an optical module including an output coupling mirror configured to transmit a part of laser light and reflect another part of the laser light, and a planar mirror including a planar reflection surface perpendicular to a surface of the output coupling mirror on an incident side of the laser light. The manufacturing jig includes a first autocollimator arranged such that light output therefrom is perpendicularly incident on the surface of the output coupling mirror on the incident side; an optical element including a first reflection surface facing the first autocollimator and a second reflection surface facing the surface on the incident side as forming an angle of 45° with the first reflection surface, and arranged between the surface on the incident side and the first autocollimator such that light output from the first autocollimator is perpendicularly incident on the first reflection surface; and a second autocollimator arranged such that light output therefrom is reflected by the second reflection surface and is perpendicularly incident on the surface on the incident side.

### BRIEF DESCRIPTION OF THE DRAWINGS

Embodiments of the present disclosure will be described below merely as examples with reference to the accompanying drawings.

FIG. 1 is a schematic view showing a schematic configuration example of an entire electronic device manufacturing apparatus.

FIG. 2 is a schematic view showing a schematic configuration example of an entire gas laser device of a comparative example.

FIG. 3 is a schematic view of an amplifier of the comparative example viewed from a direction in which a pair of electrodes face each other.

FIG. 4 is a schematic view showing a schematic configuration example of a beam expander of the comparative example.

FIG. 5 is a perspective view showing a convex mirror, a concave mirror, and a planar mirror of the comparative example.

FIG. 6 is a schematic view showing a schematic configuration example of the beam expander of a first embodiment in a similar manner as in FIG. 4.

FIG. 7 is a diagram showing an example of a flowchart of a method for manufacturing the beam expander of the first embodiment.

FIG. 8 is a view showing a state of an output coupling mirror arrangement step.

FIG. 9 is a view showing a state of a first autocollimator arrangement step.

FIG. 10 is a view showing a state of an optical element arrangement step.

FIG. 11 is a view showing a state of the optical element arrangement step shown in FIG. 10 from a direction perpendicular to an arrangement surface.

FIG. 12 is a view showing a state of a second autocollimator arrangement step.

FIG. 13 is a view showing a state of a first mirror arrangement step.

FIG. 14 is a view showing a state of a wavefront sensor arrangement step.

FIG. 15 is a view showing a state of a pinhole plate arrangement step.

FIG. 16 is a view showing a state of a reference light source arrangement step.

FIG. 17 is a view showing a state in which the concave mirror is arranged.

FIG. 18 is a view showing a state in which the convex mirror is arranged.

FIG. 19 is a view showing a part of the state shown in FIG. 18 in which the convex mirror is arranged, as viewed along an arrow A in FIG. 18.

### DESCRIPTION OF EMBODIMENTS

1. Description of electronic device manufacturing apparatus used in exposure process for electronic device
2. Description of gas laser device of comparative example

2.1 Configuration

2.2 Operation

2.3 Method for manufacturing beam expander

2.4 Problem

3. Description of beam expander and method for manufacturing beam expander of first embodiment

3.1 Configuration

3.2 Method for manufacturing beam expander

3.3 Effect

Hereinafter, an embodiment of the present disclosure will be described in detail with reference to the drawings. The embodiment described below shows some examples of the present disclosure and does not limit the contents of the present disclosure. Also, all configurations and operation described in the embodiment are not necessarily essential as configurations and operation of the present disclosure. Here, the same components are denoted by the same reference numeral, and duplicate description thereof is omitted.

### 1. Description of Electronic Device Manufacturing Apparatus Used in Exposure Process for Electronic Device

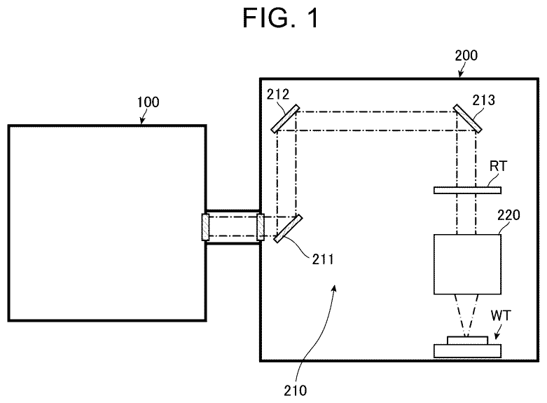

FIG. 1 is a schematic view showing a schematic configuration example of an entire electronic device manufacturing apparatus used in an exposure process for an electronic device. As shown in FIG. 1, the manufacturing apparatus used in the exposure process includes a gas laser device 100 and an exposure apparatus 200. The exposure apparatus 200 includes an illumination optical system 210 including a plurality of mirrors 211, 212, 213 and projection optical system 220. The illumination optical system 210 illuminates a reticle pattern of a reticle stage RT with laser light incident from the gas laser device 100. The projection optical system 220 causes the laser light transmitted through the reticle to be imaged as being reduced and projected on a workpiece (not shown) arranged on a workpiece table WT. The workpiece is a photosensitive substrate such as a semiconductor wafer on which photoresist is applied. The exposure apparatus 200 synchronously translates the reticle stage RT and the workpiece table WT to expose the workpiece to the laser light reflecting the reticle pattern. Through the exposure process as described above, a device pattern is transferred onto the semiconductor wafer, thereby a semiconductor device, which is the electronic device, can be manufactured.

### 2. Description of Gas Laser Device of Comparative Example

### 2.1 Configuration

The gas laser device of a comparative example will be described. The comparative example of the present disclosure is an example recognized by the applicant as known only by the applicant, and is not a publicly known example admitted by the applicant.

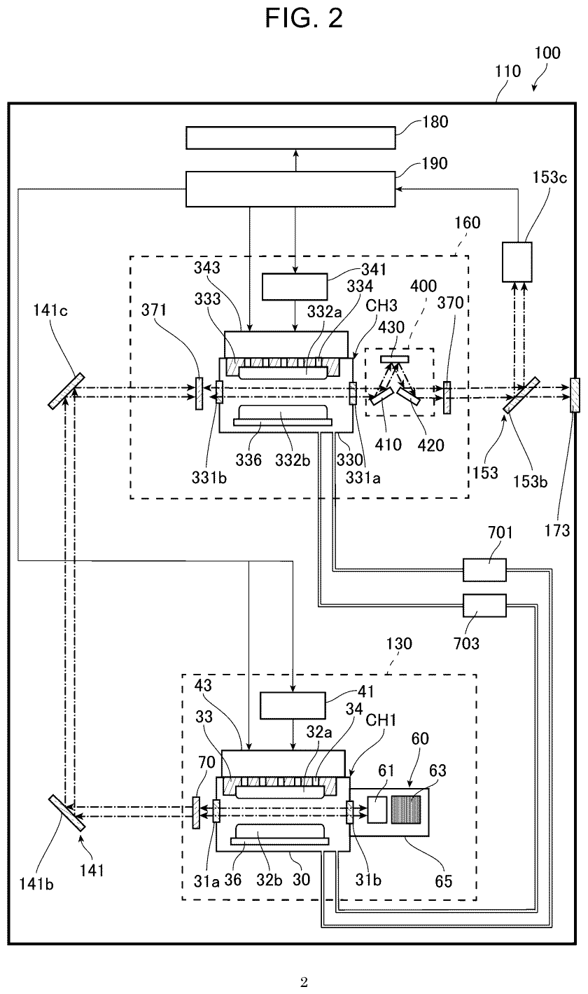

FIG. 2 schematic view showing a schematic configuration example of the entire gas laser device 100 of the present example. The gas laser device 100 is, for example, an ArF excimer laser device using a mixed gas including argon (Ar), fluorine (F₂), and neon (Ne). The gas laser device 100 outputs laser light having a center wavelength of about 193.4 nm. Here, the gas laser device 100 may be a gas laser device other than the ArF excimer laser device, and may be, for example, a KrF excimer laser device using a mixed gas including krypton (Kr), F₂, and Ne. In this case, the gas laser device 100 outputs laser light having a center wavelength of about 248.0 nm. The mixed gas containing Ar, F₂, and Ne which is a laser medium and the mixed gas containing Kr, F₂, and Ne which is a laser medium may be each referred to as a laser gas. In the mixed gas used in each of the ArF excimer laser device and the KrF excimer laser device, helium (He) may be used instead of Ne.

The gas laser device 100 of the present example includes a housing 110, a laser oscillator 130 that is a master oscillator arranged at the internal space of the housing 110, a light transmission unit 141, an amplifier 160 that is a power oscillator, a detection unit 153, a display unit 180, a processor 190, a laser gas exhaust device 701, and a laser gas supply device 703 as a main configuration. The laser oscillator 130 includes a chamber device CH1, a charger 41, a pulse power module 43, a line narrowing module 60, and an output coupling mirror 70 as a main configuration.

In FIG. 2, the internal configuration of the chamber device CH1 is shown as viewing from a direction substantially perpendicular to the travel direction of the laser light. The chamber device CH1 includes a housing 30, a pair of windows 31a, 31b, a pair of electrodes 32a, 32b, an insulating portion 33, a feedthrough 34, and an electrode holder portion 36 as a main configuration.

The housing 30 is supplied with the laser gas from the laser gas supply device 703 to the internal space of the housing 30 via a pipe, and the internal space is filled with the laser gas. The internal space is a space in which light is generated by excitation of the laser medium in the laser gas. This light travels to the windows 31a, 31b.

The window 31a is arranged at a wall surface of the housing 30 on the front side in the travel direction of the laser light from the gas laser device 100 to the exposure apparatus 200, and the window 31b is arranged at a wall surface of the housing 30 on the rear side in the travel direction. The windows 31a, 31b are calcium fluoride substrates, and surfaces of the windows 31a, 31b on the inner side and the outer side of the housing 30 are planar surfaces. Here, the windows 31a, 31b are not limited to the calcium fluoride substrate as long as being capable of transmitting the laser light.

The electrodes 32a, 32b are arranged to face each other at the internal space of the housing 30, and the longitudinal direction of the electrodes 32a, 32b are along the travel direction of the light generated by the high voltage applied between the electrode 32a and the electrode 32b. The space between the electrode 32a and the electrode 32b in the housing 30 is sandwiched between the window 31a and the window 31b. The electrodes 32a, 32b are discharge electrodes for exciting the laser medium by glow discharge. In the present example, the electrode 32a is the cathode and the electrode 32b is the anode.

The electrode 32a is supported by the insulating portion 33. The insulating portion 33 blocks an opening formed in the housing 30. The insulating portion 33 includes an insulator. Further, the feedthrough 34 made of a conductive member is arranged in the insulating portion 33. The feedthrough 34 applies a voltage, to the electrode 32a, supplied from the pulse power module 43. The electrode 32b is supported by the electrode holder portion 36 and is electrically connected to the electrode holder portion 36.

The charger 41 is a DC power source device that charges a capacitor (not shown) provided in the pulse power module 43 with a predetermined voltage. The charger 41 is arranged outside the housing 30 and is connected to the pulse power module 43. The pulse power module 43 includes a switch (not shown) controlled by the processor 190. The pulse power module 43 is a voltage application circuit that, when the switch is turned ON from OFF by the control, boosts the voltage applied from the charger 41 to generate a pulse high voltage, and applies the high voltage to the electrodes 32a, 32b. When the high voltage is applied, discharge occurs between the electrode 32a and the electrode 32b. The energy of the discharge excites the laser medium in the housing 30. When the excited laser gas shifts to a ground level, light is emitted, and the emitted light is transmitted through the windows 31a, 31b and is output to the outside of the housing 30. The windows 31a, 31b are inclined at the Brewster angle with respect to the travel direction of the laser light so that P-polarized light of the laser light is suppressed from being reflected. In the present example, the windows 31a, 31b are inclined with respect to a direction perpendicular to the travel direction of the laser light and to a direction in which the electrodes 32a, 32b face each other. Therefore, the laser light output from the chamber device CH1 includes first linear polarization whose polarization direction is perpendicular to the direction in which the electrodes 32a, 32b face each other, and linear polarization whose polarization direction differs from the polarization direction of the first linear polarization is reduced from the laser light. That is, the windows 31a, 31b also each serve as a polarizer that is inclined with respect to the polarization direction of the first linear polarization and reduces, from the laser light, the linear polarization whose polarization direction differs from the polarization direction of the first linear polarization.

The line narrowing module 60 includes a housing 65, and a prism 61, a grating 63, and a rotation stage (not shown) arranged at the internal space of the housing 65. An opening is formed in the housing 65, and the housing 65 is connected to the rear side of the housing 30 via the opening.

The prism 61 expands the beam width of the light output from the window 31b and causes the light to be incident on the grating 63. The prism 61 also reduces the beam width of the light reflected from the grating 63 and returns the light to the internal space of the housing 30 through the window 31b. The prism 61 is supported by the rotation stage and is rotated by the rotation stage. The incident angle of the light with respect to the grating 63 is changed by the rotation of the prism 61. Therefore, by rotating the prism 61, the wavelength of the light returning from the grating 63 to the housing 30 via the prism 61 can be selected. Although FIG. 2 shows an example in which one prism 61 is arranged, two or more prisms may be arranged.

The surface of the grating 63 is configured of a material having a high reflectance, and a large number of grooves are formed on the surface at predetermined intervals. The grating 63 is a dispersive optical element. The cross sectional shape of each groove is, for example, a right triangle. The light incident on the grating 63 from the prism 61 is reflected by these grooves and diffracted in a direction corresponding to the wavelength of the light. The grating 63 is arranged in the Littrow arrangement, which causes the incident angle of the light incident on the grating 63 from the prism 61 to coincide with the diffraction angle of the diffracted light having a desired wavelength. Thus, light having a desired wavelength returns to the housing 30 via the prism 61.

The output coupling mirror 70 faces the window 31a, transmits a part of the laser light output from the window 31a, and reflects another part thereof to return to the internal space of the housing 30 through the window 31a. The output coupling mirror 70 is fixed to a holder (not shown) and is arranged at the internal space of the housing 110.

The grating 63 and the output coupling mirror 70 arranged with the housing 30 interposed therebetween configure a Fabry-Perot resonator, and the housing 30 is arranged on the optical path of the resonator. Accordingly, the resonator causes the light to resonate between both sides sandwiching the chamber device CH1.

The light transmission unit 141 includes high reflection mirrors 141b, 141c as a main configuration. The high reflection mirrors 141b, 141c are fixed to respective holders (not shown) with inclination angles thereof adjusted, and are arranged at the internal space of the housing 110. The high reflection mirrors 141b, 141c highly reflect the laser light. The high reflection mirrors 141b, 141c are arranged on the optical path of the laser light from the output coupling mirror 70. The laser light is reflected by the high reflection mirrors 141b, 141c and travels to a rear mirror 371 of the amplifier 160. At least a part of the laser light is transmitted through the rear mirror 371.

The amplifier 160 amplifies the energy of the laser light output from the laser oscillator 130. The basic configuration of the amplifier 160 is substantially the same as that of the laser oscillator 130. In order to distinguish the components of the amplifier 160 from the components of the laser oscillator 130, the chamber device, the housing, the pair of windows, the pair of electrodes, the insulating portion, the feedthrough, the electrode holder portion, the charger, the pulse power module, and the output coupling mirror of the amplifier 160 are described as a chamber device CH3, a housing 330, a pair of window 331a, 331b, a pair of electrodes 332a, 332b, an insulating portion 333, a feedthrough 334, an electrode holder portion 336, a charger 341, a pulse power module 343, and an output coupling mirror 370. The electrodes 332a, 332b cause discharge for amplifying the laser light from the laser oscillator 130. The direction in which the electrodes 332a, 332b face each other is a direction perpendicular to the polarization direction of the first linear polarization in the laser light from the laser oscillator 130. The windows 331a, 331b are inclined with respect to the polarization direction of the first linear polarization so that the first linear polarization in the laser light is incident thereon as P-polarized light and an incident angle θ of the laser light becomes the Brewster angle. Therefore, the laser light output from the chamber device CH3 includes first linear polarization, and linear polarization whose polarization direction differs from the first linear polarization is reduced from the laser light. That is, similarly to the windows 31a, 31b, the windows 331a, 331b also each serve as a polarizer that is inclined with respect to the polarization direction of the first linear polarization and reduce, from the laser light, the linear polarization whose polarization direction differs from the polarization direction of the first linear polarization. Similarly to the pulse power module 43, the pulse power module 343 is a voltage application circuit.

The amplifier 160 is mainly different from the laser oscillator 130 in that the line narrowing module 60 is not included and a rear mirror 371 and a beam expander 400 as an optical module are included.

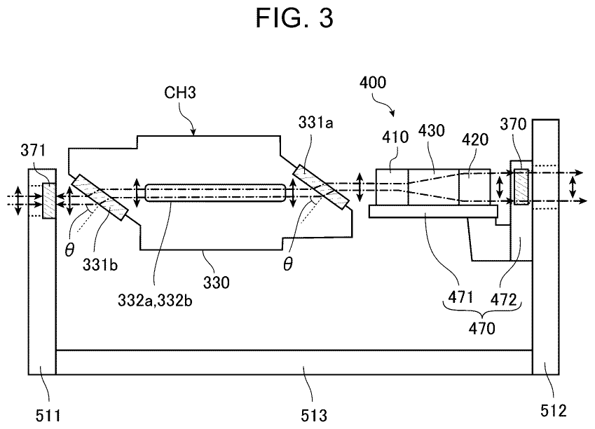

FIG. 3 is a schematic view of the amplifier 160 of the present example viewed from a direction in which the pair of electrodes 332a, 332b face each other. In FIG. 3, the internal configuration of the chamber device CH3 is shown and the polarization direction of the first linear polarization is indicated by solid arrows.

The rear mirror 371 is provided between the high reflection mirror 141c and the window 331b and faces to the both thereof. The rear mirror 371 transmits a part of the laser light from the laser oscillator 130 toward the space between the electrodes 332a, 332b, and reflects the laser light amplified by the electrodes 332a, 332b toward the space between the electrodes 332a, 332b. The rear mirror 371 is attached to a cavity plate 511 located on the window 331b side among a pair of cavity plates 511, 512 arranged so as to sandwich the chamber device CH3 in the longitudinal direction of the electrodes 332a, 332b. The cavity plate 511 is provided with a through hole through which the laser light from the laser oscillator 130 passes. The pair of cavity plates 511, 512 are connected to a cavity frame 513 extending along a direction parallel to the longitudinal direction of the electrodes 332a, 332b around the chamber device CH3. In FIG. 2, the cavity plates 511, 512 and the cavity frame 513 are omitted.

The output coupling mirror 370 is arranged on a side opposite to the rear mirror 371 with respect to the chamber device CH3, and the beam expander 400 is arranged between the chamber device CH3 and the output coupling mirror 370.

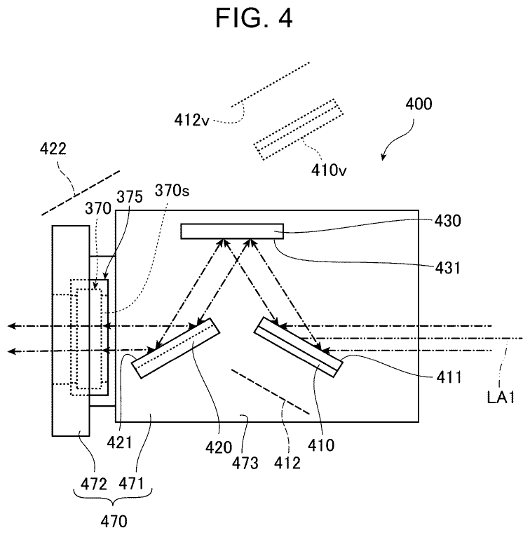

FIG. 4 is a schematic view showing a schematic configuration example of the beam expander 400 of the present example, and is a schematic view of the beam expander 400 viewed along the polarization direction of the first linear polarization. Therefore, in FIG. 4, a direction perpendicular to the paper surface is the polarization direction of the first linear polarization.

As shown in FIGS. 3 and 4, the beam expander 400 of the present example includes a convex mirror 410, a concave mirror 420, a planar mirror 430, and a holding portion 470.

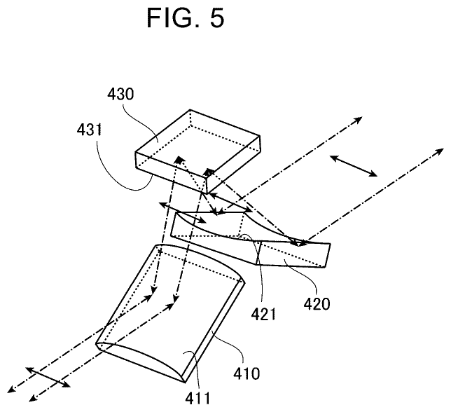

FIG. 5 is a perspective view showing the convex mirror 410, the concave mirror 420, and the planar mirror 430 of the present example. In FIG. 5, the polarization direction of the first linear polarization is indicated by solid arrows. The convex mirror 410 is a plate-like member in which one main surface is a reflection surface 411 that reflects light. The concave mirror 420 is a plate-like member in which one main surface is a reflection surface 421 that reflects light. The planar mirror 430 is a plate-like member in which one main surface is a reflection surface 431 that reflects light. The reflection surface 431 is a planar surface. The convex mirror 410 reflects the laser light from the chamber device CH3 toward the planar mirror 430 so as to expand the beam width of the laser light. The planar mirror 430 reflects the laser light reflected by the convex mirror 410 toward the concave mirror 420. The concave mirror 420 reflects the laser light toward the output coupling mirror 370 so as to collimate the laser light such that the expanded beam width of the laser light reflected by the planar mirror 430 becomes constant. The concave mirror 420 reflects the laser light from the output coupling mirror 370 toward the planar mirror 430 such that the beam width of the laser light is reduced. The planar mirror 430 reflects the laser light reflected by the concave mirror 420 toward the convex mirror 410. The convex mirror 410 reflects the laser light toward the chamber device CH3 such that the reduced beam width of the laser light reflected by the planar mirror 430 becomes constant and the laser light returns to the internal space of the housing 330 through the window 331a.

In the present example, the convex mirror 410 is a convex cylindrical mirror, and the shape of the convex mirror 410 when the reflection surface 411 is viewed from the front is a rectangle elongated in a direction parallel to a focal line 412 of the convex mirror 410. Although the shape of the reflection surface 411 in a cross section perpendicular to the focal line 412 is an arc, the shape is not limited, and may be, for example, a parabola. Further, the concave mirror 420 is a concave cylindrical mirror, and the shape of the concave mirror 420 when the reflection surface 421 is viewed from the front is a rectangle elongated in a direction parallel to the focal line 422 of the concave mirror 420. Although the shape of the reflection surface 421 in a cross section perpendicular to the focal line 422 is an arc, the shape is not limited, and may be, for example, a parabola. Here, the focal line 412 is a line connecting focal points of the convex mirror 410, and the focal line 422 is a line connecting focal points of the concave mirror 420. Further, the shapes of the convex mirror 410 and the concave mirror 420 are not limited. For example, the shape of the convex mirror 410 may be a rectangle elongated in a direction perpendicular to the focal line 412, and the shape of the concave mirror 420 may be a rectangle elongated in a direction perpendicular to the focal line 422.

As shown in FIG. 4, the focal line 412 is included in a plane including an optical axis LA1 of the laser light and extending in a direction in which the electrodes 332a, 332b face each other, and is inclined so as to approach the electrode 332a as the distance from the chamber device CH3 increases. Further, the focal line 422 is included in a plane including the optical axis LA1 of the laser light and the focal line 412, and is inclined so as to approach the electrode 332b as the distance from the chamber device CH3 increases. The reflection surface 431 of the planar mirror 430 is parallel to the optical axis LA1 of the laser light, and is perpendicular to a surface of the output coupling mirror 370 on the beam expander 400 side. The surface is a surface 370s on the incident side (hereinafter, called an incident-side surface 370s) on which the laser light from the chamber device CH3 enters. The focal line 412v of a virtual image 410v of the convex mirror 410 formed by the reflection surface 431 and the focal line 422 of the concave mirror 420 are located on the same straight line. That is, the positions of the convex mirror 410, the concave mirror 420, and the planar mirror 430 are adjusted to satisfy the above. Here, the focal line 412v and the focal line 422 may not be located on the same straight line. In FIG. 4, the virtual image 410v and the focal line 412v of the virtual image 410v are indicated by broken lines.

The holding portion 470 includes a first holding portion 471 and a second holding portion 472. The first holding portion 471 is a member that holds the convex mirror 410, the concave mirror 420, and the planar mirror 430. The first holding portion 471 includes a planar arrangement surface 473. The convex mirror 410, the concave mirror 420, and the planar mirror 430 are arranged on the arrangement surface 473. The arrangement surface 473 is parallel to the optical axis LA1 of the laser light and perpendicular to the direction in which the electrodes 332a, 332b face each other. In the present example, the convex mirror 410 is arranged on the arrangement surface 473 with one of the two side surfaces thereof extending along the longitudinal direction of the convex mirror 410 facing the arrangement surface 473. The concave mirror 420 is arranged on the arrangement surface 473 with one of the two side surfaces thereof extending along the longitudinal direction of the concave mirror 420 facing the arrangement surface 473. The planar mirror 430 is arranged on the arrangement surface 473 with one of the two side surfaces thereof extending along the longitudinal direction of the planar mirror 430 facing the arrangement surface 473. The convex mirror 410, the concave mirror 420, and the planar mirror 430 are each fixed to the arrangement surface 473 with, for example, an adhesive (not shown), and are held by the first holding portion 471. Examples of the adhesive include an ultraviolet curable resin.

The second holding portion 472 is a member that holds the output coupling mirror 370, and in the present example, is a plate-shaped member that extends in a direction substantially perpendicular to the optical axis LA1 of the laser light. An output coupling mirror holder 375 for holding the output coupling mirror 370 is fixed to and held by the second holding portion 472. The second holding portion 472 is provided with a through hole through which the laser light transmitted through the output coupling mirror 370 passes. Further, the first holding portion 471 is fixed to the second holding portion 472. The second holding portion 472 is attached to the cavity plate 512 located on the window 331a side.

The incident-side surface 370s of the output coupling mirror 370 is coated with a partial reflection film having a predetermined reflectance. The output coupling mirror 370 reflects a part of the laser light from the chamber device CH3 with the beam width thereof expanded by the beam expander 400 toward the beam expander 400, and transmits another part of the laser light.

The output coupling mirror 370 may have a circular shape. The incident-side surface 370s and the surface on the opposite side from the incident-side surface 370s are planar surfaces. The configuration of the rear mirror 371 is similar to the that of the output coupling mirror 70.

The rear mirror 371 and the output coupling mirror 370 arranged with the housing 330 interposed therebetween configure a resonator in which the laser light amplified by the electrodes 332a, 332b resonates. The housing 330 and the beam expander 400 are arranged on the optical path of the resonator. The laser light output from the window 331a of the housing 330 is incident on the output coupling mirror 370 via the beam expander 400, and a part of the laser light is reflected by the output coupling mirror 370. The laser light reflected by the output coupling mirror 370 returns to the internal space of the housing 330 via the beam expander 400 and the window 331a, and is output from the window 331b. The laser light output from the window 331b is reflected by the rear mirror 371 and returns to the internal space of the housing 330 through the window 331b. Thus, the laser light output from the housing 330 reciprocates between the rear mirror 371 and the output coupling mirror 370. The reciprocating laser light is amplified every time the laser light passes through a laser gain space between the electrode 332a and the electrode 332b. That is, the resonator resonates light between both sides sandwiching the chamber device CH3, and the output coupling mirror 370 is arranged on one side of sandwiching the chamber device CH3. A part of the amplified laser light is transmitted through the output coupling mirror 370. The laser light transmitted through the output coupling mirror 370 travels to the detection unit 153.

The detection unit 153 includes the beam splitter 153b and an optical sensor 153c as a main configuration.

The beam splitter 153b is arranged on the optical path of the laser light transmitted through the output coupling mirror 370. The beam splitter 153b transmits the laser light transmitted through the output coupling mirror 370 toward an output window 173 with a high transmittance, and reflects a part of the pulse laser light toward a light receiving surface of the optical sensor 153c.

The optical sensor 153c measures the pulse energy of the laser light incident on the light receiving surface of the optical sensor 153c. The optical sensor 153c is electrically connected to the processor 190, and outputs a signal indicating the measured pulse energy to the processor 190. The processor 190 controls the voltage to be applied to the electrodes 32a, 32b of the amplifier 160 based on the signal.

The output window 173 is provided on the opposite side of the output coupling mirror 370 with respect to the beam splitter 153b of the detection unit 153. The output window 173 is provided in a wall of the housing 110. The light transmitted through the beam splitter 153b is output from the output window 173 to the exposure apparatus 200 outside the housing 110. The laser light is, for example, pulse laser light having a center wavelength of 193.4 nm.

The display unit 180 is a monitor that displays a state of control by the processor 190 based on a signal from the processor 190. The display unit 180 may be arranged outside the housing 110.

The processor 190 of the present disclosure is a processing device including a storage device in which a control program is stored and a central processing unit (CPU) that executes the control program. The processor 190 is specifically configured or programmed to perform various processes included in the present disclosure. The processor 190 controls the entire gas laser device 100. The processor 190 is electrically connected to an exposure processor (not shown) of the exposure apparatus 200, and transmits and receives various signals to and from the exposure processor.

The laser gas exhaust device 701 and the laser gas supply device 703 are electrically connected to the processor 190 with signal lines (not shown). The laser gas exhaust device 701 includes an exhaust pump (not shown), and exhausts the laser gas from the internal spaces of the housings 30, 330 via a pipe by suction of the exhaust pump according to a control signal from the processor 190. The laser gas supply device 703 supplies the laser gas from a laser gas supply source (not shown) arranged outside the housing 110 to the internal spaces of the housings 30, 330 via a pipe according to a control signal from the processor 190.

### 2.2 Operation

Next, operation of the gas laser device 100 of the comparative example will be described.

In a state before the gas laser device 100 outputs the laser light, the laser gas is supplied from the laser gas supply device 703 to the internal spaces of the housings 30, 330.

Before the gas laser device 100 outputs the laser light, the processor 190 receives a signal indicating a target energy Et and a signal indicating the light emission trigger from the exposure processor. The target energy Et is a target value of the energy of the laser light used in the exposure process. The processor 190 sets a predetermined charge voltage to the charger 41 so that the energy E becomes the target energy Et, and turns ON the switch of the pulse power module 43 in synchronization with the light emission trigger signal. Thus, the pulse power module 43 generates a pulse high voltage from the electric energy held in the charger 41, and applies the high voltage between the electrode 32a and the electrode 32b. When the high voltage is applied, discharge occurs between the electrode 32a and the electrode 32b, the laser medium contained in the laser gas between the electrode 32a and the electrode 32b is brought into an excited state, and light is emitted when the laser medium returns to the ground state. The emitted light resonates between the grating 63 and the output coupling mirror 70, and is amplified every time passing through the discharge space at the internal space of the housing 30, so that laser oscillation occurs. The laser light includes the first linear polarization, and linear polarization whose polarization direction differs from the first linear polarization is reduced from the laser light transmitted through the windows 31a, 31b. A part of the laser light is transmitted through the output coupling mirror 70, is reflected by the high reflection mirrors 141b, 141c, is transmitted through the rear mirror 371 and the window 331b, and travels into the housing 330.

The processor 190 turns ON the switch of the pulse power module 343 so that discharge occurs when the laser light from the laser oscillator 130 travels to the discharge space in the housing 330. That is, the processor 190 controls the pulse power module 343 such that a high voltage is applied to the electrodes 332a, 332b after a predetermined delay time elapses from the timing at which the switch of the pulse power module 43 is turned ON.

Thus, the laser light having entered the amplifier 160 is amplified in the amplifier 160. Further, the laser light having traveled through the internal space of the housing 330 travels to the output coupling mirror 370 via the window 331a and the beam expander 400 as described above, and is reflected by the output coupling mirror 370. The laser light reflected by the output coupling mirror 370 travels through the internal space of the housing 330 via the beam expander 400 and the window 331a, and is output from the window 331b. The light output from the window 331b is reflected by the rear mirror 371 and travels through the internal space of the housing 330 via the window 331b. Thus, the laser light having a predetermined wavelength reciprocates between the rear mirror 371 and the output coupling mirror 370. The laser light includes the first linear polarization, and linear polarization whose polarization direction differs from the first linear polarization is reduced from the laser light transmitted through the windows 331a, 331b. Further, the laser light is amplified every time passing through the discharge space at the internal space of the housing 330, and a part of the laser light becomes amplified laser light.

At the beam expander 400, the laser light output from the chamber device CH3 is incident on the reflection surface 411 of the convex mirror 410 so that the first linear polarization in the laser light becomes S-polarized light. The reflection surface 411 reflects the laser light so that the beam width of the laser light is expanded. The laser light reflected by the convex mirror 410 is incident on the reflection surface 431 of the planar mirror 430 so that the first linear polarization in the laser light becomes S-polarized light, and the reflection surface 431 reflects the laser light toward the concave mirror 420. The laser light reflected by the planar mirror 430 is incident on the reflection surface 421 of the concave mirror 420 so that the first linear polarization in the laser light becomes S-polarized light. The reflection surface 421 reflects the laser light toward the output coupling mirror 370 so as to collimate the laser light such that the expanded beam width of the laser light becomes constant. In general, an optical element that reflects light tends to be less likely to deteriorate over time than an optical element that transmits light. Therefore, deterioration of the beam expander 400 over time is suppressed as compared with a case in which the beam expander 400 is formed of a prism that transmits light. Further, most of the polarized components included in the amplified laser light are the first linear polarization. Such laser light is incident on and reflected by the reflection surface 411, the reflection surface 421, and the reflection surface 431 that the such first linear polarization in the laser beam becomes S-polarized light. The reflectance of S-polarized light tends to be higher than that of P-polarized light. Therefore, a decrease in the amount of light at the reflection surface 411, the reflection surface 421, and the reflection surface 431 is suppressed.

The amplified laser light from the amplifier 160 is transmitted through the output coupling mirror 370 and travels to the beam splitter 153b.

A part of the amplified laser light having traveled to the beam splitter 153b is transmitted through the beam splitter 153b and the output window 173 and travels to the exposure apparatus 200, while another part is reflected by the beam splitter 153b and travels to the optical sensor 153c.

The optical sensor 153c measures the energy E of the received amplified laser light. The optical sensor 153c outputs a signal indicating the measured energy E to the processor 190. The processor 190 performs feedback control on the charge voltages of the chargers 41, 341 so that a difference ΔE between the energy E and the target energy Et is within an allowable range.

### 2.3 Method for Manufacturing Beam Expander

Next, a method for manufacturing the beam expander 400 of the comparative example will be described.

In the present example, first, the convex mirror 410, the concave mirror 420, the planar mirror 430, and the holding portion 470 holding the output coupling mirror 370 are prepared. Next, each of the convex mirror 410, the concave mirror 420, and the planar mirror 430 is arranged at a designed position on the arrangement surface 473 of the first holding portion 471, and is fixed thereto with an adhesive. Thus, the beam expander 400 is manufactured.

### 2.4 Problem

The dimensions of the convex mirror 410, the concave mirror 420, and the planar mirror 430 include manufacturing tolerances. Further, the dimensions of the designed positions of the mirrors include tolerances. Therefore, even when the mirrors are arranged at the designed positions, the performance of the laser light may deviate from the designed value, and the positions of the mirrors may be adjusted. In adjustment of the arrangement of the mirrors, when the reflection surface 431 of the planar mirror 430 is not perpendicular to the incident-side surface 370s of the output coupling mirror 370, the performance of the laser light may deviate from the designed values even if the positions of the convex mirror 410 and the concave mirror 420 are adjusted. Accordingly, there is a demand to set the reflection surface 431 perpendicular to the incident-side surface 370s so that the performance of the laser light is suppressed from deviating from the designed value.

Therefore, in the following embodiment, a method for manufacturing an optical module capable of suppressing the performance of the laser light from deviating from the designed value is exemplified.

### 3. Description of Beam Expander and Method for Manufacturing Beam Expander of First Embodiment

Next, the beam expander 400 and a method for manufacturing the beam expander 400 of a first embodiment will be described. Any component same as that described above is denoted by an identical reference sign, and duplicate description thereof is omitted unless specific description is needed. Further, in some drawings, a part of a member may be omitted or simplified for easy viewing.

### 3.1 Configuration

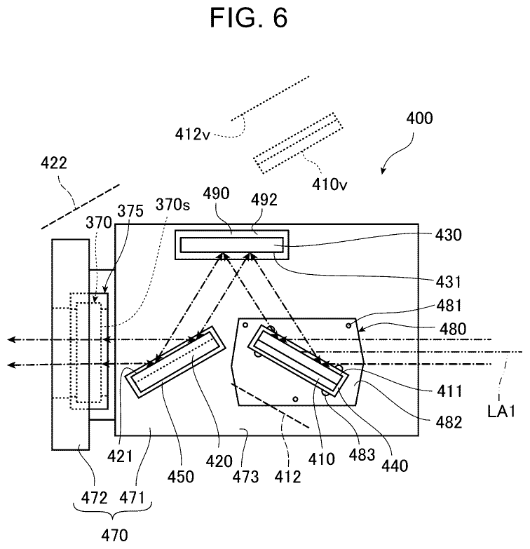

FIG. 6 is a schematic view showing a schematic configuration example of the beam expander 400 of the present embodiment in a similar manner as in FIG. 4. As shown in FIG. 6, the beam expander 400 of the present embodiment is mainly different from the beam expander 400 of the comparative example in that a convex mirror holder 440, a concave mirror holder 450, a convex mirror base 480, and a planar mirror base 490 are included.

The convex mirror holder 440 is a plate-like member extending along one of the two side surfaces extending along the longitudinal direction of the convex mirror 410, and the side surface of the convex mirror 410 is fixed to the convex mirror holder 440 with, for example, an adhesive.

The concave mirror holder 450 is a plate-like member extending along one of the two side surfaces extending along the longitudinal direction of the concave mirror 420, and the side surface of the concave mirror 420 is fixed to the concave mirror holder 450 with, for example, an adhesive. The concave mirror holder 450 is fixed to the arrangement surface 473 of the first holding portion 471 with, for example, a bolt.

The convex mirror base 480 is a member to which the convex mirror holder 440 is fixed. The convex mirror base 480 of the present embodiment is a plate-like member. The convex mirror base 480 is attached to the arrangement surface 473 with three screws 481 in a state in which one main surface of the convex mirror base 480 faces the arrangement surface 473 of the first holding portion 471. The convex mirror base 480 is spaced from the arrangement surface 473 and inclination thereof with respect to the arrangement surface 473 can be changed by the three screws 481. In FIG. 6, only one screw is denoted by a reference numeral 481. The convex mirror holder 440 is fixed to a main surface 482 of the convex mirror base 480 on a side opposite to the arrangement surface 473 with an adhesive 483. That is, the convex mirror 410 is fixed to the arrangement surface 473 via the convex mirror base 480 and the convex mirror holder 440. The adhesive 483 is separated into a plurality of adhesive portions, and the adhesive 483 is arranged between the convex mirror holder 440 and the main surface 482. Therefore, a space is formed in a region in which the convex mirror holder 440 and the main surface 482 are separated from each other and the adhesive 483 is not arranged therebetween. In FIG. 6, only one adhesive portion is denoted by a reference numeral 483. Here, the adhesive 483 may not be separated into a plurality of adhesive portions. The configuration of the convex mirror base 480 is not limited as long as the inclination thereof with respect to the arrangement surface 473 can be changed.

The planar mirror base 490 is a member to which the planar mirror 430 is fixed. The planar mirror base 490 of the present embodiment has a similar configuration as the convex mirror base 480, and is attached to the arrangement surface 473 and the inclination thereof with respect to the arrangement surface 473 can be changed. The planar mirror 430 is fixed to a main surface 492 of the planar mirror base 490 on a side opposite to the arrangement surface 473 with an adhesive (not shown). That is, the planar mirror 430 is fixed to the arrangement surface 473 via the planar mirror base 490. The adhesive fixing the planar mirror 430 may be separated into a plurality of adhesive portions similarly to the adhesive 483. The configuration of the planar mirror base 490 is not limited as long as the inclination thereof with respect to the arrangement surface 473 can be changed.

### 3.2 Method for Manufacturing Beam Expander

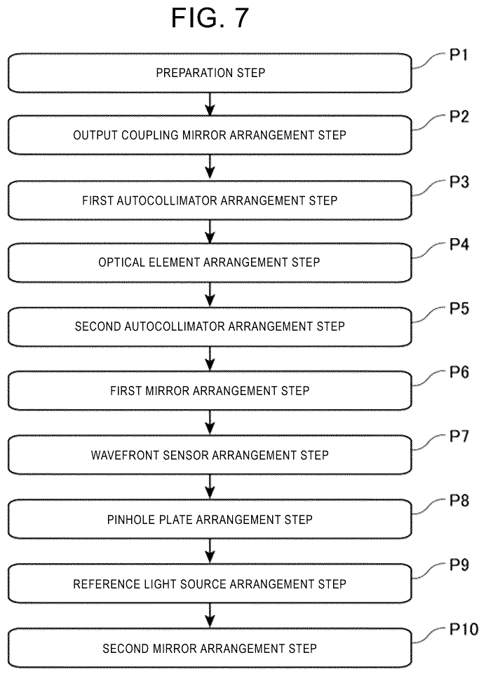

FIG. 7 is a diagram showing an example of a flowchart of a method for manufacturing the beam expander 400 of the present embodiment. Hereinafter, a method for manufacturing the beam expander 400 may be simply referred to as a manufacturing method. As shown in FIG. 7, the manufacturing method of the present embodiment includes a preparation step P1, an output coupling mirror arrangement step P2, a first autocollimator arrangement step P3, an optical element arrangement step P4, a second autocollimator arrangement step P5, a first mirror arrangement step P6, a wavefront sensor arrangement step P7, a pinhole plate arrangement step P8, a reference light source arrangement step P9, and a second mirror arrangement step P10.

### Preparation Step P1

The present step is a step of preparing components configuring the beam expander 400. In the present embodiment, the output coupling mirror 370 held by the holding portion 470, the convex mirror 410 fixed to the convex mirror holder 440, the concave mirror 420 fixed to the concave mirror holder 450, the planar mirror 430 fixed to the planar mirror base 490, and the convex mirror base 480 are prepared. Regarding the output coupling mirror 370, the orientation of the output coupling mirror 370 with respect to the holding portion 470 is adjusted such that the laser light from the chamber device CH3 is perpendicularly incident on the incident-side surface 370s by attaching the second holding portion 472 of the holding portion 470 to the cavity plate 512. Further, the arrangement surface 473 of the first holding portion 471 in the holding portion 470 is adjusted so as to be perpendicular to the incident-side surface 370s.

### Output Coupling Mirror Arrangement Step P2

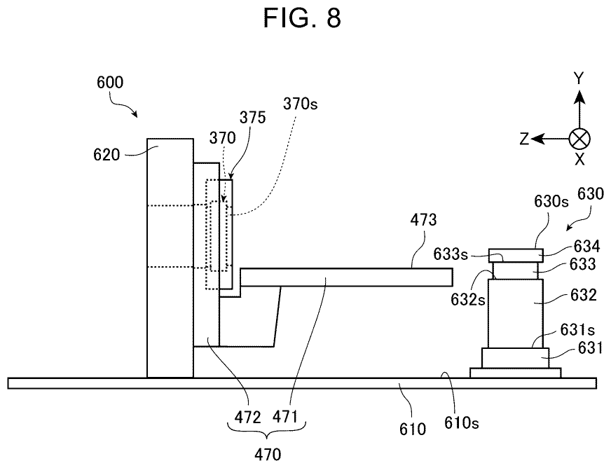

The present step is a step of arranging the output coupling mirror 370 at a predetermined position in a manufacturing jig 600 for the beam expander 400. FIG. 8 is a view showing a state in the present step. As shown in FIG. 8, the manufacturing jig 600 of the present embodiment includes a plate 610, a jig base 620, and a plurality of stages. In FIG. 8, only a first stage 630 is shown, and other stages are omitted. The plate 610 is a plate-like member in which one main surface 610s is a planar surface, and a plurality of stages can be arranged on the main surface 610s. Hereinafter, a direction perpendicular to the main surface 610s is described as a Y direction, a direction perpendicular to the Y direction is described as an X direction, and a direction perpendicular to the Y direction and the X direction is described as a Z direction.

The configuration of the jig base 620 is similar to that of the cavity plate 512, and the holding portion 470 can be attached to the jig base 620. The jig base 620 is fixed to the main surface 610s. In the present embodiment, by attaching the holding portion 470 to the jig base 620, the output coupling mirror 370 is arranged at a predetermined position.

The first stage 630 is arranged on the main surface 610s on a side opposite to the jig base 620 with respect to the holding portion 470 and includes a placement surface 630s on which a member such as a collimator described later can be placed. In the present embodiment, the first stage 630 includes a translation stage 631, an elevation stage 632, a rotation stage 633, and a gonio-stage 634. The translation stage 631 is movable in the X direction and the Z direction. The elevation stage 632 is arranged on a placement surface 631s of the translation stage 631, and can move a placement surface 632s located on a side opposite to the placement surface 631s in the Y direction. The rotation stage 633 is arranged on the placement surface 632s of the elevation stage 632, and can rotate a placement surface 633s located on a side opposite to the placement surface 632s about an axis parallel to the Y direction. The gonio-stage 634 is arranged on the placement surface 633s of the rotation stage 633, and a placement surface thereof located on a side opposite to the placement surface 633s serves as the placement surface 630s of the first stage 630. The gonio-stage 634 can incline the placement surface 630s about an axis perpendicular to the Y direction. Therefore, the first stage 630 can move the placement surface 630s in the X direction, the Y direction, and the Z direction, rotate the placement surface 630s about an axis parallel to the Y direction, and incline the placement surface 630s about an axis perpendicular to the Y direction.

### First Autocollimator Arrangement Step P3

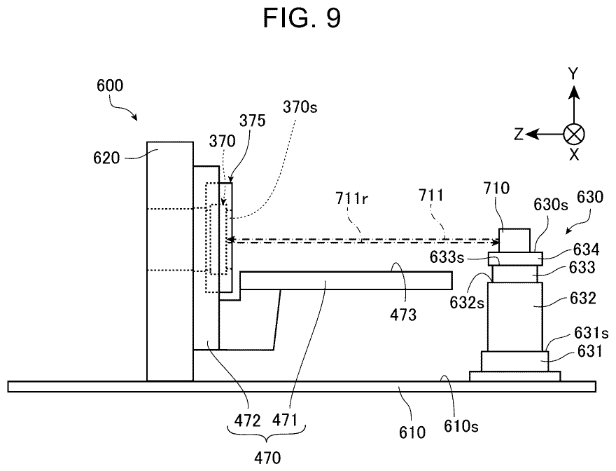

The present step is a step of arranging a first autocollimator 710 such that the light output from the first autocollimator 710 is perpendicularly incident on the incident-side surface 370s of the output coupling mirror 370. FIG. 9 is a view showing a state in the present step. In the present embodiment, the first autocollimator 710 is arranged on the placement surface 630s of the first stage 630 such that the light 711 from the first autocollimator 710 is incident on the incident-side surface 370s. Then, the first autocollimator 710 receives the light 711r reflected by the incident-side surface 370s, and the first autocollimator 710 measures the incident angle of the light 711 incident on the incident-side surface 370s. The position of the first autocollimator 710, the inclination of the first autocollimator 710 with respect to the main surface 610s, and the orientation of the first autocollimator 710 in a direction parallel to the main surface 610s are adjusted by the first stage 630 based on the measurement result. Adjustment is performed such that the light 711 output from the first autocollimator 710 is perpendicularly incident on the incident-side surface 370s. In the present embodiment, the first autocollimator 710 is arranged such that the incident angle of the light 711 on the incident-side surface 370s is equal to or less than 0.02 mrad.

### Optical Element Arrangement Step P4

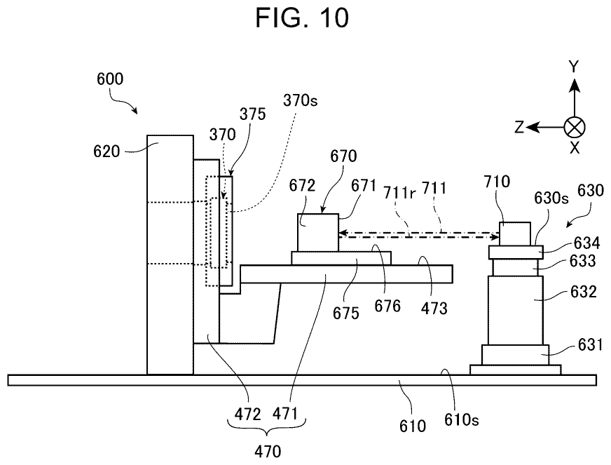

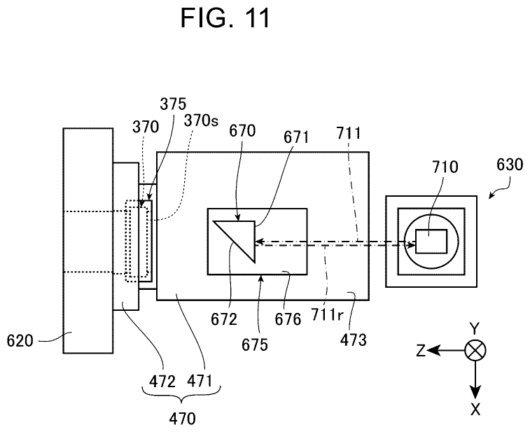

The present step is a step of arranging the optical element 670. FIG. 10 is a view showing a state in the present step. FIG. 11 is a view of the state shown in FIG. 10 viewed from a direction perpendicular to the arrangement surface 473. As shown in FIGS. 10 and 11, the optical element 670 includes a first reflection surface 671 and a second reflection surface 672. The first reflection surface 671 and the second reflection surface 672 are planar surfaces that reflect light. The second reflection surface 672 forms an angle of 45° with the first reflection surface 671. The optical element 670 of the present embodiment is a prism having a triangular prism shape, and the first reflection surface 671 and the second reflection surface 672 are each a part of the side surface of the prism. Both end surfaces of the optical element 670 in the extending direction are perpendicular to the first reflection surface 671 and the second reflection surface 672.

In the present step, the optical element 670 is arranged between the incident-side surface 370s and the first autocollimator 710 such that the light 711 output from the first autocollimator 710 is perpendicularly incident on the first reflection surface 671. At this time, the first reflection surface 671 faces the first autocollimator 710, and the second reflection surface 672 faces the incident-side surface 370s. In the present embodiment, the optical element 670 is arranged on the arrangement surface 473 of the first holding portion 471 via the optical element base 675. The optical element base 675 is arranged on the arrangement surface 473 and is rotatable about an axis perpendicular to the arrangement surface 473. The optical element base 675 includes a placement surface 676 parallel to the arrangement surface 473 on a side opposite to the arrangement surface 473. The optical element 670 is arranged on the placement surface 676 such that the light 711 of the first autocollimator 710 is incident on the first reflection surface 671. Then, the first autocollimator 710 receives light 711r reflected by the first reflection surface 671, and the first autocollimator 710 measures the incident angle of the light 711 incident on the first reflection surface 671. The optical element base 675 is rotated based on the measurement result such that the light 711 output from the first autocollimator 710 is perpendicularly incident on the first reflection surface 671. In the present embodiment, the optical element 670 is arranged such that the incident angle of the light 711 on the first reflection surface 671 is equal to or less than 0.02 mrad. Here, the inclination of the optical element base 675 with respect to the arrangement surface 473 can be changed. Further, the configuration of the optical element base 675 is not limited as long as the optical element 670 can be arranged thereon.

### Second Autocollimator Arrangement Step P5

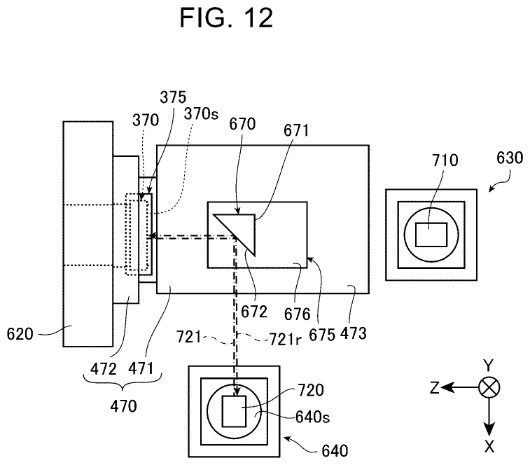

The present step is a step of arranging a second autocollimator 720 such that light output from the second autocollimator 720 is reflected by the second reflection surface 672 and is perpendicularly incident on the incident-side surface 370s. FIG. 12 is a view showing a state in the present step. As shown in FIG. 12, in the present embodiment, the second autocollimator 720 is arranged on a placement surface 640s of a second stage 640 such that light 721 from the second autocollimator 720 is reflected by the second reflection surface 672 and is incident on the incident-side surface 370s. The second stage 640 has a configuration similar to that of the first stage 630, and can move the placement surface 640s in the X direction, the Y direction, and the Z direction, rotate the placement surface 640s about an axis parallel to the Y direction, and incline the placement surface 640s about an axis perpendicular to the Y direction. Then, the second autocollimator 720 receives light 721r reflected in the order of the second reflection surface 672, the incident-side surface 370s, and the second reflection surface 672, and the second autocollimator 720 measures the incident angle of the light 721 incident on the incident-side surface 370s. Based on the measurement result, the position, the inclination, and the orientation of the second autocollimator 720 are adjusted by the second stage 640. Adjustment is performed such that the light 721 output from the second autocollimator 720 is reflected by the second reflection surface 672, and is perpendicularly incident on the incident-side surface 370s. In the present embodiment, the second autocollimator 720 is arranged such that the incident angle of the light 721 on the incident-side surface 370s is equal to or less than 0.02 mrad.

### First Mirror Arrangement Step P6

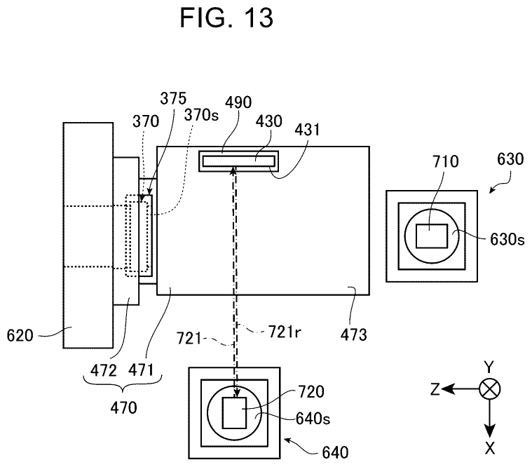

The present step is a step of removing the optical element 670 and arranging the planar mirror 430 such that the light 721 from the second autocollimator 720 is perpendicularly incident on the reflection surface 431 of the planar mirror 430. FIG. 13 is a view showing a state in the present step. As shown in FIG. 13, in the present embodiment, first, the optical element 670 and the optical element base 675 are removed from the first holding portion 471. Next, the planar mirror base 490 to which the planar mirror 430 is fixed is attached to the arrangement surface 473. That is, in the present embodiment, the planar mirror 430 is arranged on the arrangement surface 473 via the planar mirror base 490. The position at which the planar mirror base 490 is attached is a position at which the light 721 is incident on the reflection surface 431 of the planar mirror 430 and which is on a side opposite to the second autocollimator 720 with respect to the optical axis of the light 711. Then, the second autocollimator 720 receives the light 721r reflected by the reflection surface 431, and the second autocollimator 720 measures the incident angle of the light 721 incident on the reflection surface 431. Based on the measurement result, inclination of the planar mirror base 490 with respect to the arrangement surface 473 is adjusted. Adjustment is performed such that the light 721 from the second autocollimator 720 is perpendicularly incident on the reflection surface 431 of the planar mirror 430. In the present embodiment, the planar mirror 430 is arranged such that the incident angle of the light 721 on the reflection surface 431 is equal to or less than 1 mrad.

### Wavefront Sensor Arrangement Step P7

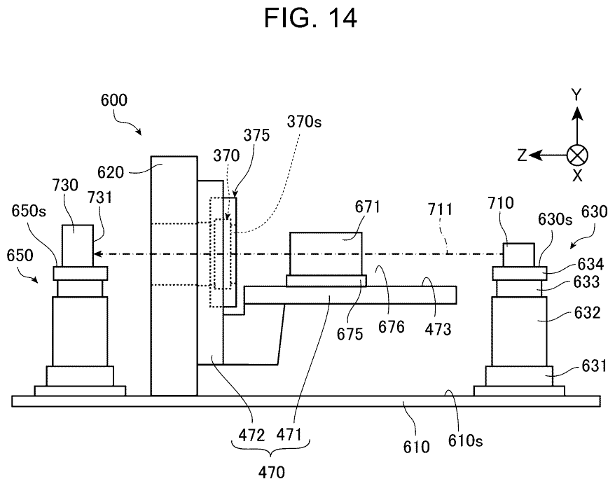

The present step is a step of arranging a wavefront such that sensor 730 the light 711 of the first autocollimator 710 transmitted through the output coupling mirror 370 is perpendicularly incident on a light receiving surface 731. FIG. 14 is a view showing a state in the present step. The wavefront sensor 730 can measure the incident angle of the incident light and wavefront aberration of the incident light. In the present embodiment, the wavefront sensor 730 is arranged on a placement surface 650s of a third stage 650 such that the light 711 from the first autocollimator 710 is transmitted through the output coupling mirror 370 and is incident on the light receiving surface 731 of the wavefront sensor 730. The third stage 650 has a configuration similar to that of the first stage 630, and can move the placement surface 650s in the X direction, the Y direction, and the Z direction, rotate the placement surface 650s about an axis parallel to the Y direction, and incline the placement surface 650s about an axis perpendicular to the Y direction. Then, the wavefront sensor 730 measures the incident angle of the light 711 incident on the light receiving surface 731. Based on the measurement result, the position, the inclination, and the orientation of the wavefront sensor 730 are adjusted by the third stage 650. Adjustment is performed such that the light 711 transmitted through the output coupling mirror 370 is perpendicularly incident on the light receiving surface 731. In the present embodiment, the wavefront sensor 730 is arranged such that the incident angle of the light 711 on the light receiving surface 731 is equal to or less than 0.05 mrad.

### Pinhole Plate Arrangement Step P8

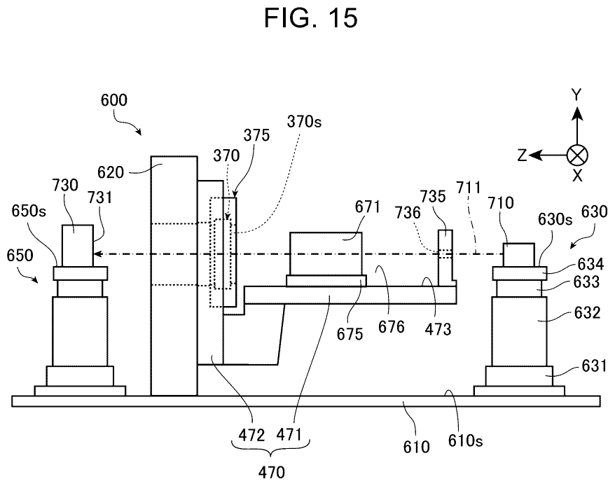

The present step is a step of arranging a pinhole plate 735 provided with a through hole 736 such that the light 711 passes through the through hole 736. FIG. 15 is a view showing a state in the present step. The pinhole plate 735 is a light shielding plate-like member in which the through hole 736 is provided in the thickness direction. In the present embodiment, the pinhole plate 735 is arranged on the arrangement surface 473 such that the optical axis of the light 711 passes through the through hole 736. The size of the through hole 736 is larger than the beam diameter of the light 711, and the light 711 can pass through the through hole 736 without being shielded. The outer shape of the through hole 736 may be a rectangle elongated in the Y direction.

### Reference Light Source Arrangement Step P9

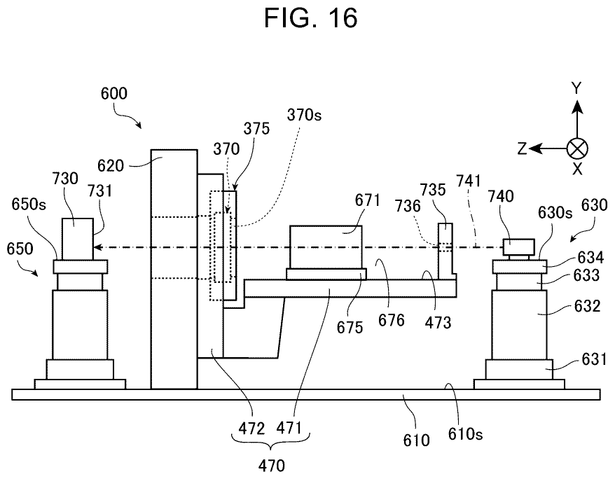

The present step is a step of arranging a reference light source 740 in place of the first autocollimator 710 such that light 741 output therefrom is transmitted through the output coupling mirror 370 and is perpendicularly incident on the light receiving surface 731 of the wavefront sensor 730. FIG. 16 is a view showing a state in the present step. The beam diameter of the light 741 output from the reference light source 740 is larger than the beam diameter of the light 711 of the first autocollimator 710. For example, the beam diameter of the light 741 is 10 times or more of the beam diameter of the light 711 and is equal to or more than 10 mm. The beam diameter of the light 741 is larger than the outer shape of the through hole 736 of the pinhole plate 735. In the present embodiment, the reference light source 740 is arranged on the placement surface 630s of the first stage 630 in place of the first autocollimator 710. Then, arrangement is performed such that the light 741 of the reference light source 740 passes through the through hole 736, is transmitted through the output coupling mirror 370, and is incident on the light receiving surface 731 of the wavefront sensor 730. Further, arrangement is performed such that the optical axis of the light 741 passes through the through hole 736, and the entire through hole 736 is located within the region at which the pinhole plate 735 is irradiated with the light 741. Therefore, the outer shape of the light 741 having passed through the through hole 736 is the same as the outer shape of the through hole 736.

Next, the incident angle of the light 741 incident on the light receiving surface 731 is measured by the wavefront sensor 730. Based on the measurement result, the position, the inclination, and the orientation of the reference light source 740 are adjusted by the first stage 630. Adjustment is performed such that the light 741 is perpendicularly incident on the light receiving surface 731. In the present embodiment, the reference light source 740 is arranged such that the incident angle of the light 741 on the light receiving surface 731 is equal to or less than 0.02 mrad.

The pinhole plate 735 may be arranged after the first autocollimator 710 is removed. For example, after the reference light source 740 is arranged, the pinhole plate 735 may be arranged such that the optical axis of the light 741 passes through the through hole 736.

### Second Mirror Arrangement Step P10

The present step is a step of arranging the convex mirror 410 and the concave mirror 420. Specifically, the convex mirror 410 is arranged such that the beam width of the light 741 of the reference light source 740 is expanded and the light 741 is reflected toward the planar mirror 430. The concave mirror 420 is arranged so as to collimate the light 741 reflected by the planar mirror 430 so that the expanded beam width of the light 741 becomes constant, and to reflect the light 741 such that the light 741 is transmitted through the output coupling mirror 370 and is perpendicularly incident on the light receiving surface 731 of the wavefront sensor 730.

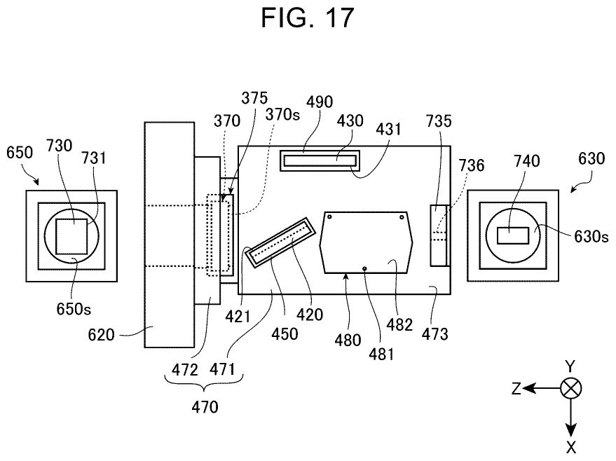

FIG. 17 is a view showing a state in which the concave mirror 420 is arranged. In the present embodiment, first, the concave mirror holder 450 to which the concave mirror 420 is fixed is arranged on the arrangement surface 473 of the first holding portion 471. That is, the concave mirror 420 is arranged on the arrangement surface 473 via the concave mirror holder 450. The position at which the concave mirror 420 is arranged is closer to the output coupling mirror 370 than the pinhole plate 735. The reflection surface 421 of the concave mirror 420 intersects the optical axis of the light 741 of the reference light source 740. The concave mirror 420 is located closer to the output coupling mirror 370 than the planar mirror 430, and is inclined toward the planar mirror 430 from the output coupling mirror 370 side toward the reference light source 740 side. The focal line 422 of the concave mirror 420 is parallel to the arrangement surface 473. That is, the position at which the concave mirror 420 is arranged is a position that satisfies the above. This position may be determined in advance on the arrangement surface 473, and positioning may be performed by a knock pin, an abutting groove, or the like. For this purpose, the concave mirror holder 450 may be provided with a hole into which a knock pin is fitted. The concave mirror holder 450 thus arranged is fixed to the arrangement surface 473 with a bolt.

Next, the convex mirror base 480 is attached to the arrangement surface 473. The position at which the convex mirror base 480 is attached is a position that overlaps the optical axis of the light 741 in a direction perpendicular to the arrangement surface 473 between the concave mirror 420 and the pinhole plate 735. This position may be determined in advance and defined by a positioning configuration similar to that of the concave mirror holder 450.

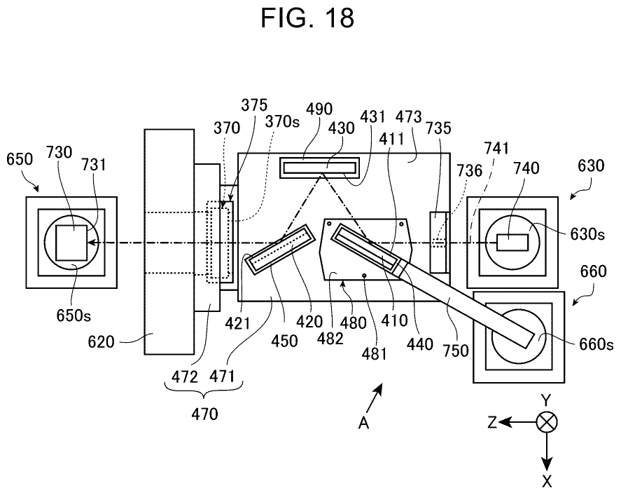

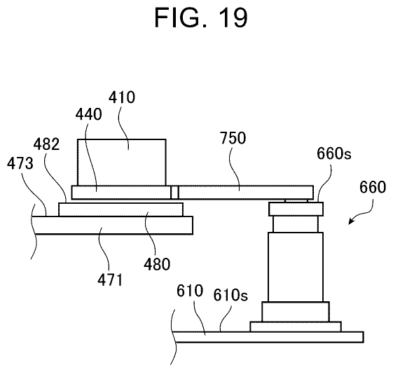

Next, the convex mirror 410 is arranged. FIG. 18 is a view showing a state in which the convex mirror 410 is arranged. FIG. 19 is a view showing a part of the state shown in FIG. 18, as viewed along an arrow A in FIG. 18. As shown in FIGS. 18 and 19, in the present embodiment, the convex mirror 410 fixed to the convex mirror holder 440 is arranged on a placement surface 660s of a fourth stage 660 via a support stay 750. The fourth stage 660 has a configuration similar to that of the first stage 630, and can move the placement surface 660s in the X direction, the Y direction, and the Z direction, rotate the placement surface 660s about an axis parallel to the Y direction, and incline the placement surface 660s about an axis perpendicular to the Y direction. The support stay 750 is a rod-shaped member to which the convex mirror holder 440 is detachably attached at one end thereof, and the other end of the support stay 750 is fixed to the placement surface 660s. The support stay 750 is moved by the fourth stage 660 such that the light 741 having passed through the through hole 736 of the pinhole plate 735 is incident on the reflection surface 411 of the convex mirror 410 while holding the convex mirror holder 440 directly above the convex mirror base 480.

Next, the position, the inclination, and the orientation of the convex mirror 410 are adjusted by the fourth stage 660. Adjustment is performed such that the light 741 reflected by the convex mirror 410 is reflected by the planar mirror 430 and the concave mirror 420 in this order and is incident on the incident-side surface 370s. At this time, the convex mirror holder 440 and the main surface 482 of the convex mirror base 480 are separated from each other by a predetermined distance or more. The predetermined distance is, for example, 0.1 mm. The convex mirror 410 expands the beam width of the light 741 and reflects the light 741 such that the light 741 is directed toward the planar mirror 430. Further, the concave mirror 420 reflects the light 741 so as to collimate the light 741 reflected by the planar mirror 430 such that the expanded beam width becomes constant. The light 741 reflected by the concave mirror 420 is transmitted through the output coupling mirror 370 and enters the wavefront sensor 730.

Next, the wavefront sensor 730 measures the incident angle of the light 741 incident on the light receiving surface 731 and a root mean square (RMS) value of wavefront aberration of the light 741. Based on the measurement result, the position, the inclination, and the orientation of the convex mirror 410 are adjusted by the fourth stage 660 such that the light 741 transmitted through the output coupling mirror 370 is perpendicularly incident on the wavefront sensor 730. Thus, the focal line 412v of the virtual image 410v of the convex mirror 410 and the focal line 422 of the concave mirror 420 are positioned on the same straight line. In the present embodiment, the reference light source 740 is arranged such that the incident angle of the light 741 on the light receiving surface 731 is equal to or less than 0.2 mrad and the RMS value of wavefront aberration of the light 741 is equal to or less than 13.51 nm (=0.07×193 nm). When wavefront aberration is not to be considered, the RMS value of wavefront aberration of the light 741 incident on the light receiving surface 731 may not be measured by the wavefront sensor 730.

Next, the fourth stage 660 moves the convex mirror holder 440 in the Y direction by a predetermined distance so that the convex mirror holder 440 approaches the convex mirror base 480. The predetermined distance is shorter than the distance between the convex mirror holder 440 and the convex mirror base 480 before moving, and is, for example, 0.1 mm. Next, the inclination of the convex mirror base 480 is adjusted such that the main surface 482 of the convex mirror base 480 is in surface contact with the convex mirror holder 440. Next, the fourth stage 660 moves the convex mirror holder 440 in the Y direction by a predetermined distance so that the convex mirror holder 440 moves away from the convex mirror base 480. The predetermined distance is the same as the distance by which the convex mirror holder 440 is moved to approach the convex mirror base 480. Then, the incident angle of the light 741 incident on the light receiving surface 731 and the RMS value of wavefront aberration of the light 741 are measured again, and based on the measured result, the position, the inclination, and the orientation of the convex mirror 410 are adjusted by the fourth stage 660 such that the light 741 is perpendicularly incident on the wavefront sensor 730. Therefore, a gap of a predetermined distance is formed between the convex mirror holder 440 and the main surface 482 of the convex mirror base 480 in a state in which the light 741 is perpendicularly incident on the wavefront sensor 730. Here, adjustment of the position, the inclination, and the orientation of the convex mirror 410 after moving the convex mirror holder 440 in the Y direction such that the convex mirror holder 440 moves away from the convex mirror base 480 may be omitted. Further, the movement of the convex mirror holder 440 in the Y direction and the adjustment of the convex mirror 410 after the first adjustment of the convex mirror 410 may be omitted.

Next, the convex mirror holder 440 is fixed to the convex mirror base 480 with an adhesive in a state in which the convex mirror holder 440 is separated from the convex mirror base 480. The fixing with the adhesive is as described with reference to FIG. 6. After the adhesive is solidified, the support stay 750 is removed from the convex mirror holder 440 and the pinhole plate 735 is removed from the arrangement surface 473.

Thus, the beam expander 400 is manufactured. The holding portion 470 of the beam expander 400 is attached to the cavity plate 512. As described above, the orientation of the output coupling mirror 370 with respect to the holding portion 470 is adjusted in advance. Therefore, by attaching the holding portion 470 to the cavity plate 512, the beam expander 400 is arranged such that the laser light output from the chamber device CH3 is perpendicularly incident on the incident-side surface 370s. Thus, the gas laser device 100 is manufactured.

### 3.3 Effect

The manufacturing method of the present embodiment includes the first autocollimator arrangement step P3, the optical element arrangement step P4, the second autocollimator arrangement step P5, and the first mirror arrangement step P6. In the first autocollimator arrangement step P3, the first autocollimator 710 is arranged such that the light 711 reflected by the incident-side surface 370s of the output coupling mirror 370 out of the output light 711 is received and the light 711 is perpendicularly incident on the incident-side surface 370s. That is, the optical axis of the light 711 can be set perpendicular to the incident-side surface 370s. In the optical element arrangement step P4, the optical element 670 is arranged such that the light 711 reflected by the first reflection surface 671 of the optical element 670 out of the light 711 output from the first autocollimator 710 is received and the light 711 is perpendicularly incident on the first reflection surface 671. In the second autocollimator arrangement step P5, the second autocollimator 720 is arranged such that the light 721 reflected by the second reflection surface 672 of the optical element 670, the incident-side surface 370s, and the second reflection surface 672 in this order out of the output light 721 is received and the light 721 is perpendicularly incident on the incident-side surface 370s. The angle between the first reflection surface 671 and the second reflection surface 672 is 45°. Therefore, the optical axis of the light 721 can be set perpendicular to the optical axis of the light 711 by the second autocollimator arrangement step P5. In the first mirror arrangement step P6, the planar mirror 430 is arranged such that the light 721 reflected by the reflection surface 431 of the planar mirror 430 out of the light 721 output from the second autocollimator 720 is received and the light 721 is perpendicularly incident on the reflection surface 431. Since the optical axis of the light 711 is perpendicular to the incident-side surface 370s and the optical axis of the light 721 and the optical axis of the light 711 are perpendicular to each other, the reflection surface 431 of the planar mirror 430 can be set to be perpendicular to the surface 370s on the incident side. Therefore, as compared with a case in which the planar mirror 430 is arranged at the designed position with mechanical accuracy, the deviation, from perpendicularity, of the angle formed between the reflection surface 431 and the incident-side surface 370s can be reduced. Therefore, according to the manufacturing method of the present embodiment, by adjusting the arrangement of the convex mirror 410 and the concave mirror 420, the performance of the laser light can be set to have a designed value, and it is possible to suppress the performance of the laser light from deviating from the designed value.

In the optical element arrangement step P4 in the manufacturing method of the present embodiment, the optical element 670 is arranged on the arrangement surface 473 via the optical element base 675 that is rotatable about an axis perpendicular to the arrangement surface 473. Therefore, compared with a case in which the optical element 670 is arranged directly on the arrangement surface 473 not via the optical element base 675, fine adjustment is easily performed and arrangement of the light 711 to be perpendicularly incident on the first reflection surface 671 is facilitated. Here, the optical element base 675 may be arranged directly on the arrangement surface 473.

In the second mirror arrangement step P10 in the manufacturing method of the present embodiment, the concave mirror 420 is fixed to the holding portion 470 before arranging the convex mirror 410. The convex mirror 410 is located on a side opposite to the output coupling mirror 370 side with respect to the concave mirror 420. Therefore, in the arrangement of the convex mirror 410, the output coupling mirror 370 is less likely to be an obstacle than in the arrangement of the concave mirror 420. Therefore, the second mirror arrangement step P10 can be performed more easily than a case in which the convex mirror 410 is fixed to the holding portion 470 before arranging the concave mirror 420. Here, the convex mirror 410 may be fixed to the holding portion 470 before the concave mirror 420 is arranged.

In the second mirror arrangement step P10 in the manufacturing method of the present embodiment, the convex mirror 410 is arranged on the holding portion 470 via the convex mirror base 480 whose inclination with respect to the arrangement surface 473 can be changed. Therefore, compared with a case in which the convex mirror 410 is directly arranged on the holding portion 470 not via the convex mirror base 480, the convex mirror 410 whose orientation and the like is adjusted can be easily arranged in the holding portion 470. Here, the concave mirror 420 may be arranged on the holding portion 470 via a concave mirror base capable of changing the inclination with respect to the arrangement surface 473 similarly to the convex mirror base 480.

In the second mirror arrangement step P10 in the manufacturing method of the present embodiment, the convex mirror holder 440 is fixed to the convex mirror base 480 with an adhesive in a state in which the convex mirror holder 440 to which the convex mirror 410 is fixed is separated from the convex mirror base 480. For example, when the convex mirror holder 440 is fixed to the convex mirror base 480 with a bolt, the convex mirror holder 440 may be inclined with respect to the convex mirror base 480 due to a fastening force of the bolts, and the position of the convex mirror 410 may be deviated. According to the manufacturing method of the present embodiment, it is possible to suppress the position of the convex mirror 410 from being deviated as compared with the above case. Here, the convex mirror holder 440 may be fixed with a bolt.

In the reference light source arrangement step P9 in the manufacturing method of the present embodiment, the reference light source 740 is arranged such that the optical axis of the light 741 passes through the through hole 736 of the pinhole plate 735 provided with the through hole 736 smaller than the beam diameter of the light 741 of the reference light source 740. Further, in the second mirror arrangement step P10, the convex mirror 410 and the concave mirror 420 are arranged closer to the output coupling mirror 370 than the pinhole plate 735. Therefore, the outer shape of the light 741 can be made to have a shape corresponding to the outer shape of the through hole 736. Thus, for example, the arrangement of the convex mirror 410 and the concave mirror 420 may be adjusted so that the characteristics of wavefront aberration of the laser light having a desired outer shape satisfy a desired requirement.

Although the embodiment of the present invention has been described above as examples, the above-described embodiment can be modified as appropriate. For example, although the optical element 670 is a prism including the first reflection surface 671 and the second reflection surface 672, the optical element 670 may be a columnar reflection member through which light is not transmitted.

Further, in the second mirror arrangement step P10, the concave mirror 420 is arranged on the arrangement surface 473 of the holding portion 470 via the concave mirror holder 450. However, the concave mirror 420 may be arranged directly on the arrangement surface 473, and the concave mirror 420 may be arranged on a surface different from the arrangement surface 473 on which the planar mirror 430 is arranged.

Further, in the second mirror arrangement step P10, the convex mirror 410 is arranged on the convex mirror base 480 via the convex mirror holder 440. However, the convex mirror 410 may be arranged directly on the convex mirror base 480. Further, the convex mirror 410 may be arranged directly on the holding portion 470, or may be arranged directly on the arrangement surface 473, for example.

The manufacturing method of the above embodiment is a method for manufacturing the beam expander 400 as an optical module. However, the optical module is not limited to the beam expander 400.

Further, although the manufacturing method of the above embodiment includes the pinhole plate arrangement step P8, it is not necessary to include the pinhole plate arrangement step P8.

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that the embodiments of the present disclosure would be appropriately combined. The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of the any thereof and any other than A, B, and C.

What is claimed is:

1. A method for manufacturing an optical module including an output coupling mirror configured to transmit a part of laser light and reflect another part of the laser light, and a planar mirror including a planar reflection surface perpendicular to a surface of the output coupling mirror on an incident side of the laser light,
the method comprising:
a first autocollimator arrangement step for arranging a first autocollimator such that light output from the first autocollimator is perpendicularly incident on the surface on the incident side, while receiving light, out of the light output from the first autocollimator, reflected by the surface on the incident side;
an optical element arrangement step for arranging, between the surface on the incident side and the first autocollimator, an optical element including a first reflection surface facing the first autocollimator and a second reflection surface facing the surface on the incident side as forming an angle of 45° with the first reflection surface such that light output from the first autocollimator is perpendicularly incident on the first reflection surface, while receiving light, out of the light output from the first autocollimator, reflected by the first reflection surface;
a second autocollimator arrangement step for arranging a second collimator such that light output from the second autocollimator is perpendicularly incident on the surface on the incident side, while receiving light, out of the light output from the second autocollimator, reflected by the second reflection surface, the surface on the incident side, and the second reflection surface in this order; and
a first mirror arrangement step for arranging the planar mirror, after removing the optical element, such that light output from the second autocollimator is perpendicularly incident on the reflection surface, while receiving light, out of the light output from the second autocollimator, reflected by the reflection surface of the planar mirror.

2. The method for manufacturing the optical module according to claim 1,
wherein the optical element is a prism in which the first reflection surface and the second reflection surface are each a part of a side surface thereof.

3. The method: manufacturing the optical module according to claim 1,
wherein the optical module further includes a holding portion that holds the output coupling mirror, and
in the first mirror arrangement step, the planar mirror is arranged on the holding portion.

4. The method for manufacturing the optical module according to claim 3,
wherein the holding portion includes an arrangement surface on which the planar mirror is to be arranged, and
in the optical element arrangement step, the optical element is arranged on the arrangement surface via an optical element base that is rotatable about an axis perpendicular to the arrangement surface.

5. The method for manufacturing the optical module according to claim 3,
wherein the holding portion includes an arrangement surface on which the planar mirror is to be arranged, and
in the first mirror arrangement step, the planar mirror is arranged on the arrangement surface via a planar mirror base whose inclination with respect to the arrangement surface is changeable.

6. The method for manufacturing the optical module according to claim 1, the optical module further including a convex mirror and a concave mirror,
the method further including:
a wavefront sensor arrangement step for arranging a wavefront sensor, after the first mirror arrangement step, such that light output from the first autocollimator and transmitted through the output coupling is mirror perpendicularly incident on a light receiving surface of the wavefront sensor;
a reference light source arrangement step for arranging a reference light source, configured to output light having a beam diameter larger than a beam diameter of the light output from the first autocollimator, in place of the first autocollimator such that the light output from the reference light source is transmitted through the output coupling mirror and is perpendicularly incident on the light receiving surface of the wavefront sensor; and
a second mirror arrangement step for arranging the convex mirror and the concave mirror,
wherein, in the second mirror arrangement step,
the convex mirror is arranged such that a beam width of the light output from the reference light source is expanded and the light is reflected toward the planar mirror, and
the concave mirror is arranged so as to collimate the light reflected by the planar mirror so that the expanded beam width of the light becomes constant, and so as to reflect the light such that the light is transmitted through the output coupling mirror and is perpendicularly incident on the light receiving surface of the wavefront sensor.

7. The method for manufacturing the optical module according to claim 6,
wherein the optical module further includes a holding portion that holds the output coupling mirror, and
in the second mirror arrangement step, the convex mirror and the concave mirror are arranged on the holding portion.

8. The method for manufacturing the optical module according to claim 7,
wherein, in the second mirror arrangement step, the concave mirror is fixed to the holding portion before the convex mirror is arranged.

9. The method for manufacturing the optical module according to claim 7,
wherein the holding portion includes an arrangement surface on which the planar mirror is to be arranged, and
in the second mirror arrangement step, the convex mirror is arranged on the holding portion via a convex mirror base whose inclination with respect to the arrangement surface is changeable.

10. The method for manufacturing the optical module according to claim 9,
wherein, in the second mirror arrangement step, the convex mirror is arranged on the convex mirror base via a convex mirror holder.

11. The method for manufacturing the optical module according to claim 10,
wherein, in the second mirror arrangement step, the convex mirror holder is fixed to the convex mirror base with an adhesive in a state in which the convex mirror holder is separated from the convex mirror base.

12. The method for manufacturing the optical module according to claim 6,
wherein, in the reference light source arrangement step, the reference light source is arranged such that an optical axis of the light output from the reference light source passes through a through hole formed in a pinhole plate, the through hole being smaller than a beam diameter of the light output from the reference light source, and
in the second mirror arrangement step, the convex mirror and the concave mirror are arranged closer to the output coupling mirror than the pin hole plate.

13. A method for manufacturing a gas laser device including a chamber device configured to amplify laser light output from a laser oscillator and an optical module, the optical module including an output coupling mirror configured to transmit a part of the laser light output from the chamber device and reflect another part of the laser light output from the chamber device to be returned to the chamber device, and a planar mirror including a planar reflection surface perpendicular to a surface of the output coupling mirror on an incident side of the laser light,
the method comprising arranging the optical module manufactured by a method for manufacturing the optical module such that the laser light output from the chamber device is perpendicularly incident on the surface of the output coupling mirror on the incident side,
the method for manufacturing the optical module including:
a first autocollimator arrangement step for arranging a first autocollimator such that light output from the first autocollimator is perpendicularly incident on the surface on the incident side, while receiving light, out of the light output from the first autocollimator, reflected by the surface on the incident side;
an optical element arrangement step for arranging, between the surface on the incident side and the first autocollimator, an optical element including a first reflection surface facing the first autocollimator and a second reflection surface facing the surface on the incident side as forming an angle of 45° with the first reflection surface such that light output from the first autocollimator is perpendicularly incident on the first reflection surface, while receiving light, out of the light output from the first autocollimator, reflected by the first reflection surface;
a second autocollimator arrangement step for arranging a second collimator such that light output from the second autocollimator is perpendicularly incident on the surface on the incident side, while receiving light, out of the light output from the second autocollimator, reflected by the second reflection surface, the surface on the incident side, and the second reflection surface in this order; and
a first mirror arrangement step for arranging the planar mirror, after removing the optical element, such that light output from the second autocollimator is perpendicularly incident on the reflection surface, while receiving light, out of the light output from the second autocollimator, reflected by the reflection surface of the planar mirror.

14. A manufacturing jig for an optical module including an output coupling mirror configured to transmit a part of laser light and reflect another part of the laser light, and a planar mirror including a planar reflection surface perpendicular to a surface of the output coupling mirror on an incident side of the laser light,
the manufacturing jig comprising:
a first autocollimator arranged such that light output therefrom is perpendicularly incident on the surface of the output coupling mirror on the incident side;
an optical element including a first reflection surface facing the first autocollimator and a second reflection surface facing the surface on the incident side as forming an angle of 45° with the first reflection surface, and arranged between the surface on the incident side and the first autocollimator such that light output from the first autocollimator is perpendicularly incident on the first reflection surface; and
a second autocollimator arranged such that light output therefrom is reflected by the second reflection surface and is perpendicularly incident on the surface on the incident side.
